(19) United States
(12) Patent Application Publication
(10) Pub. No.: US 2023/0385486 A1
(43) Pub. Date: Nov. 30, 2023

(54) Method for improving monitoring capability of borehole-surface micro-seismic monitoring system

(71) Applicants: CHINA UNIVERSITY OF MINING AND TECHNOLOGY, Xuzhou (CN); Xuzhou Hongyi Technology Development Co., Ltd., Xuzhou (CN)

(72) Inventors: Siyuan GONG, Xuzhou (CN); Qing GE, Xuzhou (CN); Linming DOU, Xuzhou (CN)

(73) Assignees: CHINA UNIVERSITY OF MINING AND TECHNOLOGY, Xuzhou (CN); Xuzhou Hongyi Technology Development Co., Ltd., Xuzhou (CN)

(21) Appl. No.: 18/128,233

(22) Filed: Mar. 30, 2023

(30) Foreign Application Priority Data
May 27, 2022 (CN) 202210587749.5

(51) Int. Cl. G06F 30/27; G01V 1/28; G06Q 50/02

(52) U.S. Cl. CPC G06F 30/27; G01V 1/288; G06Q 50/02; G06F 2111/06

(57) ABSTRACT

A method for improving a monitoring capability of a borehole-surface micro-seismic monitoring system includes selecting multiple candidate points for installing surface wireless sensors to form a natural-number-coded candidate point set and combining a fixed number of candidate points randomly selected from the candidate point set with an underground installed sensor set to form a borehole-surface micro-seismic monitoring network; carrying out multiple random selections until a certain scale of borehole-surface micro-seismic monitoring network deployment plans are generated; establishing an evaluation model for a monitoring capability of each borehole-surface micro-seismic monitoring network deployment plan according to a propagation relation equation between a micro-seismic energy and a first-arrival peak amplitude of a P-wave, forming an initial population; determining an optimal borehole-surface micro-seismic monitoring network deployment plan through a genetic algorithm; and determining an optimal surface wireless sensor deployment plan that significantly improves the monitoring capability of the borehole-surface micro-seismic monitoring network deployment plan.

### CROSS-REFERENCE TO THE RELATED APPLICATION

This application is based upon and claims priority to Chinese Patent Application No. 202210587749.5, filed on May 27, 2022, the entire content of which is incorporated herein by reference.

### TECHNICAL FIELD

The present disclosure relates to a method for improving a monitoring capability of a borehole-surface micro-seismic monitoring system, and belongs to the technical field of coal mine safety.

### BACKGROUND

Rock burst is one of the major disasters in coal mines and accurate monitoring and early warning of rock burst has been a difficult problem for the industry.

As the most reliable means of monitoring and early warning for rock burst, micro-seismic monitoring technology plays an important role in the temporal-spatial early warning of rock burst. Generally, if the micro-seismic monitoring system can acquire and record rich micro-seismic signals, it can clearly reflect the evolution trend of rock burst. In field application in recent years, the on-site adverse conditions have seriously affected the reliability of micro-seismic monitoring and the accuracy of early warning analysis, limiting the monitoring effectiveness. The on-site adverse conditions include blind heading, the fracture of overlying strata in the far field behind the goaf, and the operation of belt and material transportation equipment. Due to the on-site adverse conditions, it is impossible to effectively cover and surround the target area with underground sensors, and there is a lot of ambient noise, which greatly limits the complete acquisition and reliable analysis of micro-seismic signals.

At present, according to the location of the mining and production area, surface sensors and underground sensors are combined to form a borehole-surface micro-seismic monitoring network, which can significantly improve the monitoring capability of the micro-seismic monitoring system. However, the installation positions of surface sensors are mainly selected and designed based on workers' experience. This is not scientific and cannot meet the requirements of effectively deploying the borehole-surface micro-seismic monitoring system on site to completely monitor and record micro-seismic signals generated in mining and production.

### SUMMARY

In view of the problems existing in the prior art, the present disclosure provides a method for improving a monitoring capability of a borehole-surface micro-seismic monitoring system. The present disclosure can determine an optimal installation position for a surface monitoring sensor, and significantly improve the observation capability of a borehole-surface micro-seismic monitoring system, such that the borehole-surface micro-seismic monitoring system can completely acquire micro-seismic signals of various energy levels generated in mining and production.

In order to achieve the above objective, the present disclosure provides the following technical solution. The method for improving a monitoring capability of a borehole-surface micro-seismic monitoring system includes the following steps:
(1) selecting multiple candidate points for installing surface wireless sensors to form a natural-number-coded candidate point set S={1,2,3,4,5, . . . , n};
(2) combining a fixed number, namely m, of candidate points randomly selected from the candidate point set S formed in step (1) with an underground installed sensor set U to form a borehole-surface micro-seismic monitoring network deployment plan Gᵥ=[S₂¹ S₄² . . . Sₙ₋₂^{m} U₁ U₂ . . . Uₖ];
where, S₂¹ denotes a candidate point that is a first candidate point randomly selected from the candidate point set S and is a second candidate point in the candidate point set S; similarly, Sₙ₋₂^{m} denotes a candidate point that is an m-th candidate point randomly selected from the candidate point set S and is an (n−2)-th candidate point in the candidate point set S; and k denotes a number of underground sensors;
(3) repeating step (2) until v=p borehole-surface micro-seismic monitoring network deployment plans are generated to form ap-scale deployment plan set G:

$$G = [ \begin{matrix}{G}_{1} \\ {G}_{2} \\ ⋮ \\ {G}_{p}\end{matrix} ]$$

(4) forming, by each borehole-surface micro-seismic monitoring network deployment plan Gᵥ generated in step (3), an initial population Gen:
401) determining, according to a micro-seismic signal acquired by the underground sensor, a propagation relation equation between a micro-seismic energy E and a first-arrival peak amplitude f of a P-wave:

$$f = E {α}_{1} \frac{1}{r} {e}^{- {α}_{2} r}$$

where, α₁ denotes an amplitude-energy ratio coefficient; α₂ denotes an attenuation coefficient; and r denotes a distance from a micro-seismic source to the underground sensor;
402) forming a three-dimensional (3D) equidistant grid model including

$${m}_{1} \times {n}_{1} \times {p}_{1} = floor ( \frac{X max - X min}{dx} + 1 ) \times floor ( \frac{Y max - Y min}{dy} + 1 ) \times floor ( \frac{Z max - Z min}{dz} + 1 )$$

grids with an X-direction spacing dx, a Y-direction spacing dy, and a Z-direction spacing dz for a mining and production area defined by [Xmin,Xmax], [Ymin,Ymax], and [Zmin,Zmax], where m₁, n₁, and p₁ denote a number of X-direction grids, a number of Y-direction grids, and a number of Z-direction grids, respectively;
403) rewriting the propagation relation equation determined in step 401) to obtain

$$E = \frac{fr}{{α}_{1} {e}^{- {α}_{2} r}} ;$$

and calculating a minimum micro-seismic energy E_{i,j,k}^{min} to trigger the borehole-surface micro-seismic monitoring network deployment plan Gᵥ to record the micro-seismic signal, at a point (Xᵢ, Yⱼ, Zₖ) in the 3D equidistant grid model formed in step 402);
where, i∈1,2, . . . , m1; j∈1,2, . . . , n1; k∈1,2, . . . , p1; v∈1,2, . . . , p;
404) establishing, according to step 403), an evaluation model for a monitoring capability Qᵥ of the borehole-surface micro-seismic monitoring network deployment plan Gᵥ:

$${Q}_{v} = \frac{{\sum }_{i = 1}^{{m}_{1}} {\sum }_{j = 1}^{{n}_{1}} {\sum }_{k = 1}^{{p}_{1}} {E}_{i , j , k}^{min}}{{m}_{1} {n}_{1} {p}_{1}}$$

405) forming the initial population Gen:

$$Gen = [ \begin{matrix}{G}_{1} & {Q}_{1} \\ {G}_{2} & {Q}_{2} \\ ⋮ & ⋮ \\ {G}_{p} & {Q}_{p}\end{matrix} ]$$

(5) determining, according to the initial population formed in step (4), an optimal borehole-surface micro-seismic monitoring network deployment plan through a genetic algorithm, and determining an optimal surface wireless sensor deployment plan.

Further, in step (1), the multiple candidate points selected for installing the surface wireless sensors satisfy the following conditions: the candidate points cooperate with the underground sensors to surround the mining and production area; the candidate points have a distance of no more than 2,000 m from the mining and production area; the candidate points avoid a waterlogged area, a surface water system, a highway facility, and a noisy place; and the candidate points provide strong fourth-generation/fifth-generation (4G/5G) network signals.

Further, step 401) includes: determining α₁ and α₂ as follows: manually marking the first-arrival peak amplitude f of the P-wave recorded by each underground sensor; calculating a source position and micro-seismic energy E of multiple micro-seismic signals with different energy levels; calculating a distance r from the micro-seismic source to the underground sensor; and determining α₁ and α₂ by a nonlinear least squares (NLS) method.

Further, in step 403), the calculating a minimum micro-seismic energy E_{i,j,k}^{min} to trigger the borehole-surface micro-seismic monitoring network deployment plan Gᵥ to record the micro-seismic signal, at a point (Xᵢ, Yⱼ, Zₖ) includes:
40301: determining, according to a micro-seismic positioning principle based on a first arrival time of the P-wave, that the micro-seismic monitoring system is triggered to record the micro-seismic signal when the first-arrival peak amplitude f of the P-wave received by at least four sensors is greater than or equal to three times an ambient noise level NL;
40302: calculating a distance rₗ from the point (Xᵢ, Yⱼ, Zₖ) to each sensor in the borehole-surface micro-seismic monitoring network deployment plan Gᵥ; determining, according to step 40301, a first-arrival peak amplitude fₗ, of the P-wave required to trigger each sensor; and back-calculating, according to the propagation relation equation between the micro-seismic energy E and the first-arrival peak amplitude f of the P-wave determined in step 401, a micro-seismic energy E_{i,j,k}^{l} required to trigger each sensor:

$${E}_{i , j , k}^{l} = \frac{{f}_{l} {r}_{l}}{{α}_{1} {e}^{- {α}_{2} {r}_{l}}} ,$$

$$where , l = 1 , 2 , … , m + k$$

40303: sorting, according to step 40301, the micro-seismic energy E_{i,j,k}^{l} calculated in step 40302 in an ascending order; and selecting a fourth micro-seismic energy after the sorting as the minimum micro-seismic energy E_{i,j,k}^{min} to trigger the borehole-surface micro-seismic monitoring network deployment plan to record the micro-seismic signal.

Further, in step 40301, the ambient noise level NL includes a surface ambient noise level NLₛ monitored by the surface sensor installed on a surface and an underground ambient noise level NLᵤ monitored by the underground sensor installed in an underground roadway.

Further, in step (5), the genetic algorithm sets a generation number of not less than 100; and the genetic algorithm carries out mutation operation through a mixture of adjacent gene mutation, gene insertion mutation, gene exchange mutation, three-point gene exchange mutation, and two-point inversion mutation, and carries out crossover operation through a mixture of partially mapped crossover, cycle crossover operator, edge recombination crossover, linear sequential crossover, ordered crossover operator, and uniform crossover.

The present disclosure selects multiple candidate points for installing surface wireless sensors to form a natural-number-coded candidate point set, and combines a fixed number of candidate points randomly selected from the candidate point set with an underground installed sensor set to form a borehole-surface micro-seismic monitoring network. The present disclosure carries out multiple random selections until a certain scale of borehole-surface micro-seismic monitoring network deployment plans are generated. The present disclosure establishes an evaluation model for a monitoring capability of each borehole-surface micro-seismic monitoring network deployment plan according to a propagation relation equation between the micro-seismic energy and the first-arrival peak amplitude of the P-wave, and forms an initial population. The present disclosure determines an optimal borehole-surface micro-seismic monitoring network deployment plan through a genetic algorithm, and determines an optimal surface wireless sensor deployment plan that significantly improves the monitoring capability of the borehole-surface micro-seismic monitoring network deployment plan. The present disclosure provides effective guidance for the on-site adjustment and optimization of the installation position of the surface wireless sensor and ensures that the borehole-surface micro-seismic monitoring system can observe the micro-seismic activities of various energy levels generated during the mining and production process of a mine. Therefore, the present disclosure significantly improves the reliability of the micro-seismic monitoring system for the monitoring of rock burst and the accuracy of early warning analysis.

### BRIEF DESCRIPTION OF THE DRAWINGS

FIG. 1 is a flowchart of a method for improving a monitoring capability of a borehole-surface micro-seismic monitoring system according to the present disclosure;

FIG. 2 shows a comparison between original data and fitted data of a first-arrival peak amplitude f of a P-wave according to an embodiment;

FIG. 3 shows a three-dimensional (3D) grid model formed according to the embodiment; and

FIG. 4 shows a process of determining an optimal individual in an initial population according to an evaluation value of a monitoring capability based on a generation number according to the embodiment.

### DETAILED DESCRIPTION OF THE EMBODIMENTS

The present disclosure is further described below with reference to the accompanying drawings.

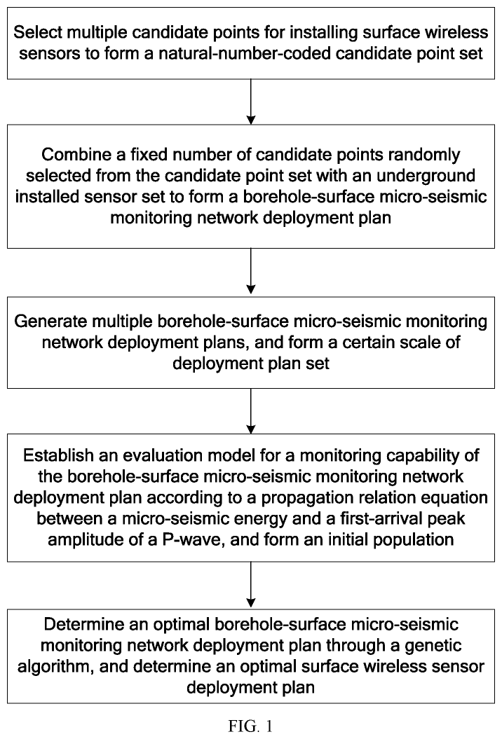

As shown in FIG. 1, a method for improving a monitoring capability of a borehole-surface micro-seismic monitoring system includes the following steps:
(1) Multiple candidate points for installing surface wireless sensors are selected to form a natural-number-coded candidate point set S={1,2,3,4,5, . . . , n}.
(2) A fixed number, namely m, of candidate points randomly selected from the candidate point set S formed in step (1) are combined with underground installed sensor set U to form a borehole-surface micro-seismic monitoring network deployment plan Gᵥ=[S₂¹ S₄^{2 . . . S}ₙ₋₂^{m} U₁ U₂ . . . Uₖ].
S₂¹ denotes a candidate point that is a first candidate point randomly selected from the candidate point set S and is a second candidate point in the candidate point set S; similarly, Sₙ₋₂^{m} denotes a candidate point that is an m-th candidate point randomly selected from the candidate point set S and is an (n−2)-th candidate point in the candidate point set S; and k denotes a number of underground sensors.
(3) Step (2) is repeated until v=p borehole-surface micro-seismic monitoring network deployment plans are generated to form ap-scale deployment plan set G:

$$G = [ \begin{matrix}{G}_{1} \\ {G}_{2} \\ ⋮ \\ {G}_{p}\end{matrix} ]$$

(4) Each borehole-surface micro-seismic monitoring network deployment plan Gᵥ generated in step (3) is combined to form an initial population Gen.
401) According to a micro-seismic signal acquired by the underground sensor, a propagation relation equation between micro-seismic energy E and first-arrival peak amplitude f of a P-wave is determined:

$$f = E {α}_{1} \frac{1}{r} {e}^{- {α}_{2} r}$$

where, α₁ denotes an amplitude-energy ratio coefficient; α₂ denotes an attenuation coefficient; and r denotes a distance from a micro-seismic source to the underground sensor.
402) A three-dimensional (3D) equidistant grid model including

$${m}_{1} \times {n}_{1} \times {p}_{1} = floor ( \frac{X max - X min}{dx} + 1 ) \times floor ( \frac{Y max - Y min}{dy} + 1 ) \times floor ( \frac{Z max - Z min}{dz} + 1 )$$

grids with an X-direction spacing dx, a Y-direction spacing dy, and a Z-direction spacing dz is formed for a mining and production area defined by [Xmin,Xmax], [Ymin,Ymax], and [Zmin,Zmax], where m₁, n₁, and p₁ denote a number of X-direction grids, a number of Y-direction grids, and a number of Z-direction grids, respectively.
403) The propagation relation equation determined in step 401) is rewritten to obtain

$$E = \frac{fr}{{α}_{1} {e}^{- {α}_{2} r}} ;$$

and minimum micro-seismic energy E_{i,j,k}^{min} to trigger the borehole-surface micro-seismic monitoring network deployment plan Gᵥ to record the micro-seismic signal, at point (Xᵢ, Yⱼ, Zₖ) in the 3D equidistant grid model formed in step 402) is calculated.

i∈1,2, . . . , m1; j∈1,2, . . . , n1; k∈1,2, . . . , p1, v∈1,2, . . . , p.
404) According to step 403), an evaluation model for a monitoring capability Qᵥ of the borehole-surface micro-seismic monitoring network deployment plan Gᵥ is established.

$${Q}_{v} = \frac{{\sum }_{i = 1}^{{m}_{1}} {\sum }_{j = 1}^{{n}_{1}} {\sum }_{k = 1}^{{p}_{1}} {E}_{i , j , k}^{min}}{{m}_{1} {n}_{1} {p}_{1}}$$

405) The initial population Gen is formed as follows:

$$Gen = [ \begin{matrix}{G}_{1} & {Q}_{1} \\ {G}_{2} & {Q}_{2} \\ ⋮ & ⋮ \\ {G}_{p} & {Q}_{p}\end{matrix} ]$$

(5) According to the initial population formed in step (4), an optimal borehole-surface micro-seismic monitoring network deployment plan is determined through a genetic algorithm and an optimal surface wireless sensor deployment plan is determined.

Further, in step (1), the multiple candidate points selected for installing the surface wireless sensors satisfy the following conditions: the candidate points cooperate with the underground sensors to surround the mining and production area; the candidate points have a distance of no more than 2,000 m from the mining and production area; the candidate points avoid a waterlogged area, a surface water system, a highway facility, and a noisy place; and the candidate points provide strong fourth-generation/fifth-generation (4G/5G) network signals.

Further, in step 401), α₁ and α₂ are determined as follows. The first-arrival peak amplitude f of the P-wave recorded by each underground sensor is manually marked and a source position and micro-seismic energy E of multiple micro-seismic signals with different energy levels are calculated. A distance r from the micro-seismic source to the underground sensor is calculated. α₁ and α₂ are determined by a nonlinear least squares (NLS) method.

Further, in step 403), the minimum micro-seismic energy E_{i,j,k}^{min} to trigger the borehole-surface micro-seismic monitoring network deployment plan Gᵥ to record the micro-seismic signal, at a point (Xᵢ, Yⱼ, Zₖ) in the grid model is calculated as follows:
40301. According to a micro-seismic positioning principle based on a first arrival time of the P-wave, it is determined that the micro-seismic monitoring system is triggered to record the micro-seismic signal when the first-arrival peak amplitude f of the P-wave received by at least four sensors is greater than or equal to three times an ambient noise level NL.
40302. A distance r₁ from the point (Xᵢ, Yⱼ, Zₖ)) to each sensor in the borehole-surface micro-seismic monitoring network deployment plan Gᵥ is calculated. According to step 40301, a first-arrival peak amplitude fₗ of the P-wave required to trigger each sensor is determined. According to the propagation relation equation between the micro-seismic energy E and the first-arrival peak amplitude f of the P-wave determined in step 401, micro-seismic energy E_{i,j,k}^{l} required to trigger each sensor is back-calculated.

$${E}_{i , j , k}^{l} = \frac{{f}_{l} {r}_{l}}{{α}_{1} {e}^{- {α}_{2} {r}_{l}}} ,$$

where, l=1,2, . . . , m+k
40303. According to step 40301, the micro-seismic energy E_{i,j,k}^{l} calculated in step 40302 is sorted in an ascending order. A fourth micro-seismic energy after the sorting is selected as the minimum micro-seismic energy E_{i,j,k}^{min} to trigger the borehole-surface micro-seismic monitoring network deployment plan to record the micro-seismic signal.

Further, in step 40301, the ambient noise level NL includes a surface ambient noise level NLₛ, monitored by the surface sensor installed on a surface and an underground ambient noise level NLᵤ monitored by the underground sensor installed in an underground roadway.

Further, in step (5), the genetic algorithm sets a generation number of not less than 100; and the genetic algorithm carries out mutation operation through a mixture of adjacent gene mutation, gene insertion mutation, gene exchange mutation, three-point gene exchange mutation, and two-point inversion mutation, and carries out crossover operation through a mixture of partially mapped crossover, cycle crossover operator, edge recombination crossover, linear sequential crossover, ordered crossover operator, and uniform crossover.

### Embodiment

(1) Multiple candidate points for installing surface wireless sensors are selected to form a natural-number-coded candidate point set S={1, 2, 3, 4, 5, . . . , 72}. The coordinates of each candidate point in the set are provided in the following table.

| SN | x/m | y/m | z/m |
|---|---|---|---|
| 1 | 19381846 | 4321678 | 1400 |
| 2 | 19381846 | 4321878 | 1400 |
| 3 | 19381846 | 4322078 | 1400 |
| 4 | 19381846 | 4322278 | 1400 |
| 5 | 19381846 | 4322478 | 1400 |
| 6 | 19381846 | 4322678 | 1400 |
| 7 | 19381846 | 4322878 | 1400 |
| 8 | 19381846 | 4323078 | 1400 |
| 9 | 19382046 | 4321678 | 1400 |
| 10 | 19382046 | 4321878 | 1400 |
| 11 | 19382046 | 4322078 | 1400 |
| 12 | 19382046 | 4322278 | 1400 |
| 13 | 19382046 | 4322478 | 1400 |
| 14 | 19382046 | 4322678 | 1400 |
| 15 | 19382046 | 4322878 | 1400 |
| 16 | 19382046 | 4323078 | 1400 |
| 17 | 19382246 | 4321678 | 1400 |
| 18 | 19382246 | 4321878 | 1400 |
| 19 | 19382246 | 4322078 | 1400 |
| 20 | 19382246 | 4322278 | 1400 |
| 21 | 19382246 | 4322478 | 1400 |
| 22 | 19382246 | 4322678 | 1400 |
| 23 | 19382246 | 4322878 | 1400 |
| 24 | 19382246 | 4323078 | 1400 |
| 25 | 19382446 | 4321678 | 1400 |
| 26 | 19382446 | 4321878 | 1400 |
| 27 | 19382446 | 4322078 | 1400 |
| 28 | 19382446 | 4322278 | 1400 |
| 29 | 19382446 | 4322478 | 1400 |
| 30 | 19382446 | 4322678 | 1400 |
| 31 | 19382446 | 4322878 | 1400 |
| 32 | 19382446 | 4323078 | 1400 |
| 33 | 19382646 | 4321678 | 1400 |
| 34 | 19382646 | 4321878 | 1400 |
| 35 | 19382646 | 4322078 | 1400 |
| 36 | 19382646 | 4322278 | 1400 |
| 37 | 19382646 | 4322478 | 1400 |
| 38 | 19382646 | 4322678 | 1400 |
| 39 | 19382646 | 4322878 | 1400 |
| 40 | 19382646 | 4323078 | 1400 |
| 41 | 19382846 | 4321678 | 1400 |
| 42 | 19382846 | 4321878 | 1400 |
| 43 | 19382846 | 4322078 | 1400 |
| 44 | 19382846 | 4322278 | 1400 |
| 45 | 19382846 | 4322478 | 1400 |
| 46 | 19382846 | 4322678 | 1400 |
| 47 | 19382846 | 4322878 | 1400 |
| 48 | 19382846 | 4323078 | 1400 |
| 49 | 19383046 | 4321678 | 1400 |
| 50 | 19383046 | 4321878 | 1400 |
| 51 | 19383046 | 4322078 | 1400 |
| 52 | 19383046 | 4322278 | 1400 |
| 53 | 19383046 | 4322478 | 1400 |
| 54 | 19383046 | 4322678 | 1400 |
| 55 | 19383046 | 4322878 | 1400 |
| 56 | 19383046 | 4323078 | 1400 |
| 57 | 19383246 | 4321678 | 1400 |
| 58 | 19383246 | 4321878 | 1400 |
| 59 | 19383246 | 4322078 | 1400 |
| 60 | 19383246 | 4322278 | 1400 |
| 61 | 19383246 | 4322478 | 1400 |
| 62 | 19383246 | 4322678 | 1400 |
| 63 | 19383246 | 4322878 | 1400 |
| 64 | 19383246 | 4323078 | 1400 |
| 65 | 19383446 | 4321678 | 1400 |
| 66 | 19383446 | 4321878 | 1400 |
| 67 | 19383446 | 4322078 | 1400 |
| 68 | 19383446 | 4322278 | 1400 |
| 69 | 19383446 | 4322478 | 1400 |
| 70 | 19383446 | 4322678 | 1400 |
| 71 | 19383446 | 4322878 | 1400 |
| 72 | 19383446 | 4323078 | 1400 |

(2) A fixed number, namely 5, of candidate points randomly selected from the candidate point set S formed in step (1) are combined with an underground installed sensor set U to form a borehole-surface micro-seismic monitoring network deployment plan G₁.

G₁=[S₂¹S₄²S₂₀³S₃₄⁴S₆₉⁵U₁U₂U₃U₄]

In the plan, S₂¹ denotes a candidate point that is a 1^{st} candidate point randomly selected from the candidate point set S and is a 2^{nd} candidate point in the candidate point set S; similarly, S₆₉⁵ denotes a candidate point that is a 5^{th} candidate point randomly selected from the candidate point set S and is a 69^{th} candidate point in the candidate point set S; and k=4 denotes a number of underground sensors. The coordinates of the sensors are provided in the following table.

| U | x/m | y/m | z/m |
|---|---|---|---|
| U₁ | 19382780.65 | 4322747.45 | 693.80 |
| U₂ | 19382493.17 | 4322201.48 | 696.80 |
| U₃ | 19382492.86 | 4322681.22 | 692.80 |
| U₄ | 19382780.95 | 4322183.56 | 697.00 |

(3) Step (2) is repeated until v=100 borehole-surface micro-seismic monitoring network deployment plans are generated to form a p=100-scale deployment plan set G:

$$G = [ \begin{matrix}{G}_{1} \\ {G}_{2} \\ ⋮ \\ ⋮ \\ {G}_{100}\end{matrix} ] = [ \begin{matrix}{S}_{2}^{1} & {S}_{4}^{2} & {S}_{20}^{3} & {S}_{34}^{4} & {S}_{69}^{5} & {U}_{1} & {U}_{2} & {U}_{3} & {U}_{4} \\ {S}_{1}^{1} & {S}_{8}^{2} & {S}_{37}^{3} & {S}_{65}^{4} & {S}_{72}^{5} & {U}_{1} & {U}_{2} & {U}_{3} & {U}_{4} \\ & & & & ⋮ & & & & \\ & & & & ⋮ & & & & \\ {S}_{5}^{1} & {S}_{33}^{2} & {S}_{37}^{3} & {S}_{40}^{4} & {S}_{68}^{5} & {U}_{1} & {U}_{2} & {U}_{3} & {U}_{4}\end{matrix} ]$$

(4) Each borehole-surface micro-seismic monitoring network deployment plan Gᵥ generated in step (3) is combined to form an initial population Gen.
401) According to a micro-seismic signal acquired by the underground sensor, a propagation relation equation between a micro-seismic energy E and a first-arrival peak amplitude f of a P-wave is determined as follows:

$$f = E {α}_{1} \frac{1}{r} {e}^{- {α}_{2} r}$$

α₁ denotes an amplitude-energy ratio coefficient; α₂ denotes an attenuation coefficient; and r denotes a distance from a micro-seismic source to the underground sensor. α₁ and α₂ are determined as follows. Three micro-seismic signals of different energy levels are selected and their micro-seismic energy and source position are calculated as follows:

| Micro- | | | | Micro- |
|---|---|---|---|---|
| seismic | Source position | | | seismic |
| signal | x/m | y/m | z/m | energy E/J |
| 1 | 19382734.46 | 4322782.88 | 727.02 | 2.60E+2 |
| 2 | 19382591.66 | 4322777.12 | 746.85 | 7.74E+3 |
| 3 | 19382648.81 | 4322816.84 | 752.25 | 4.10E+4 |

The first-arrival peak amplitude f of the P-wave recorded by the underground sensors is manually marked and a distance r from the micro-seismic source to the underground sensor is calculated as follows:

| | First-arrival amplitude | Distance from source | Micro-seismic |
|---|---|---|---|
| SN | of P-wave f/(m/s) | to sensor r/m | energy E/J |
| 1 | 2.9281E−05 | 67.025 | 2.60E+2 |
| 2 | 2.9587E−06 | 264.341 | 2.60E+2 |
| 3 | 8.4109E−07 | 630.206 | 2.60E+2 |
| 4 | 1.70725E−07 | 753.718 | 2.60E+2 |
| 5 | 1.00089E−04 | 147.918 | 7.74E+3 |
| 6 | 4.61004E−05 | 198.524 | 7.74E+3 |
| 7 | 1.18401E−05 | 586.146 | 7.74E+3 |
| 8 | 3.15171E−06 | 625.003 | 7.74E+3 |
| 9 | 1.48796E−04 | 160.041 | 4.10E+4 |
| 10 | 7.20168E−05 | 215.052 | 4.10E+4 |
| 11 | 1.92005E−05 | 637.155 | 4.10E+4 |
| 12 | 6.50699E−06 | 649.274 | 4.10E+4 |

The data are brought into the propagation relation equation between the micro-seismic energy E and the first-arrival peak amplitude f of a P-wave.

$$f = E {α}_{1} \frac{1}{r} {e}^{- {α}_{2} r}$$

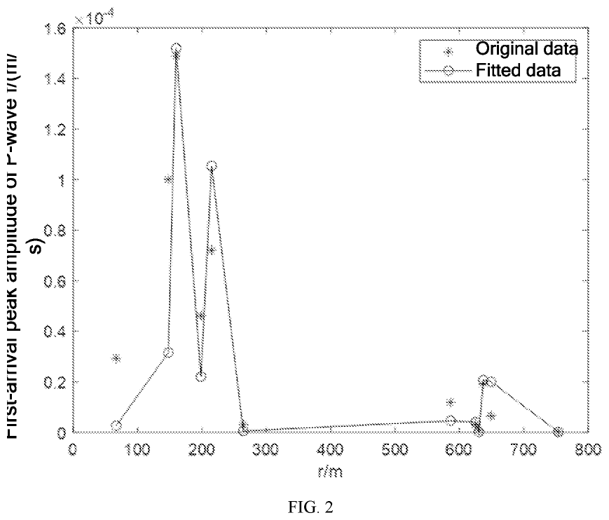

According to the NLS method, it is determined that α₁ and α₂ are 7.28352×10⁻⁷ and 0.0012836 respectively and a comparison between the original data and fitted data of the first-arrival peak amplitude f of the P-wave is plotted, as shown in FIG. 2.
402) As shown in FIG. 3, a 3D equidistant grid model including m₁×n₁×p₁=14×10×5 grids with an X-direction spacing dx=50, a Y-direction spacing dy=50, and a Z-direction spacing dz=50 for a mining and production area defined by [Xmin=19382312,Xmax=19382962], [Ymin=4322587,Ymax=4323037], and [Zmin=600,Zmax=800].
403) According to the propagation relation equation determined in step 401), the micro-seismic energy is:

$$E = \frac{f r}{7.28352 \times 1 {0}^{- 7} {e}^{- 0.0012836 r}} ,$$

The minimum micro-seismic energy E_{i,j,k}^{min} to trigger the borehole-surface micro-seismic monitoring network deployment plan Gᵥ to record the micro-seismic signal, at the point (Xᵢ, Yⱼ, Zₖ) in the 3D equidistant grid model formed in step 402) is calculated, i∈1,2, . . . , 14; j∈1,2, . . . , 10; k∈1,2, . . . , 5; v∈1,2, . . . 100. The minimum micro-seismic energy E_{1,1,1}^{min} to trigger the borehole-surface micro-seismic monitoring network deployment plan G₂=G₂=[S₁¹S₈²S₃₇³S₆₅⁴S₇₂⁵U₁U₂U₃U₄] to record the micro-seismic signal at the point [X₁=19382312, Y₁=4322587, Z₁=600] is calculated as follows:
40301. According to a micro-seismic positioning principle based on a first arrival time of the P-wave, it is determined that the micro-seismic monitoring system is triggered to record the micro-seismic signal when the first-arrival peak amplitude f of the P-wave received by at least four sensors is greater than or equal to three times an ambient noise level NL. The ambient noise level NL includes a surface ambient noise level NLₛ=2.0×10⁻⁸ m/s monitored by the surface sensor installed on a surface and an underground ambient noise level NLᵤ=5.0×10⁻⁷ m/s monitored by the underground sensor installed in an underground roadway. Specifically, the surface sensor satisfies f≥3×2.0×10⁻⁸ m/s=6×10⁻⁸ m/s, and the underground sensor satisfies f≥3×5.0×10⁻⁷ m/s=1.5×10⁻⁶ m/s.
40302. A distance r={1297, 1048, 874, 1659, 1472, 504, 437, 224, 626} from the point [X₁=19382312, Y₁=4322857, Z₁=600] to each sensor in the borehole-surface micro-seismic monitoring network deployment plan G₂ is calculated. According to step 40301, a first-arrival peak amplitude of the P-wave required to trigger each sensor is determined as follows:

f={6×10⁻⁸,6×10⁻⁸,6×10⁻⁸,6×10⁻⁸,1.5×10⁻⁶,1.5×10⁻⁶,1.5×10⁻⁶,1.5×10 ^{-6}}
40303. According to the propagation relation equation

$$\frac{{f}_{l} \times {r}_{l}}{7.28352 \times 1 {0}^{- 7} \times {e}^{- 0.0012 \; 836 \times {r}_{l}}}$$

between the micro-seismic energy E and the first-arrival peak amplitude f of the P-wave determined in step 401, a micro-seismic energy required to trigger each sensor is back-calculated as follows:

E_{1,1,1}^{l}={565.2, 331.4, 220.9, 1149.4, 802.4, 1983.2, 1576.1, 615.2, 2880.8}.The micro-seismic energy calculated is sorted in an ascending order. A fourth micro-seismic energy in {220.9, 331.4, 565.2, 615.2, 802.4 , 1149.4, 1576.1, 1983.2, 2880.8} is selected as the minimum micro-seismic energy E_{1,1,1}^{min}=615.2 to trigger the borehole-surface micro-seismic monitoring network deployment plan to record the micro-seismic signal.

Steps 40302 and 40303 are repeated until the E_{i,j,k}^{min} at all points in the grid model is calculated.
404) According to step 403), an evaluation model for a monitoring capability Qᵥ of the borehole-surface micro-seismic monitoring network deployment plan Gᵥ is established.

$${Q}_{v} = \frac{{\sum }_{i = 1}^{{m}_{1}} {\sum }_{j = 1}^{{n}_{1}} {\sum }_{k}^{{p}_{1}} {E}_{i , j , k}^{min}}{{m}_{1} {n}_{1} {p}_{1}}$$

For example, the monitoring capability of the borehole-surface micro-seismic monitoring network deployment plan G₂ is calculated as follows:

$${Q}_{2} = \frac{{\sum }_{i = 1}^{14} {\sum }_{j = 1}^{10} {\sum }_{k = 1}^{5} {E}_{i , j , k}^{min}}{14 \times 10 \times 5} = 638.67$$

The monitoring capabilities of the borehole-surface micro-seismic monitoring network deployment plan set G are calculated as follows:

$$Q = [ \begin{matrix}503.66 \\ 638.67 \\ ⋮ \\ 486.99\end{matrix} ]$$

405) The initial population Gen is formed as follows:

$$Gen = [ \begin{matrix}{S}_{2}^{1} & {S}_{4}^{2} & {S}_{20}^{3} & {S}_{34}^{4} & {S}_{69}^{5} & {U}_{1} & {U}_{2} & {U}_{3} & {U}_{4} & 503.66 \\ {S}_{1}^{1} & {S}_{8}^{2} & {S}_{37}^{3} & {S}_{65}^{4} & {S}_{72}^{5} & {U}_{1} & {U}_{2} & {U}_{3} & {U}_{4} & 638.67 \\ & & & & ⋮ & & & & & ⋮ \\ {S}_{5}^{1} & {S}_{33}^{2} & {S}_{37}^{3} & {S}_{40}^{4} & {S}_{68}^{5} & {U}_{1} & {U}_{2} & {U}_{3} & {U}_{4} & 486.99\end{matrix} ]$$

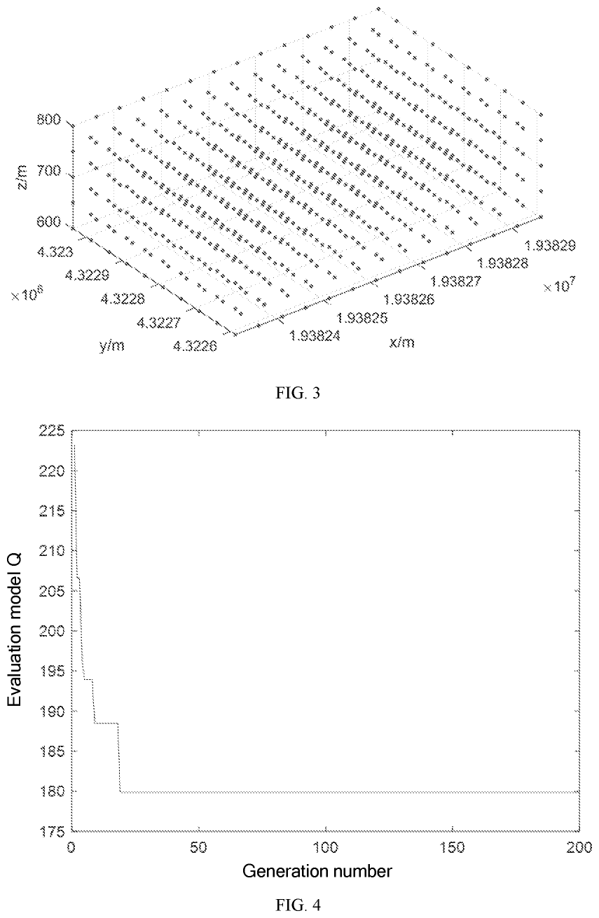

(5) As shown in FIG. 4, an optimal individual of the initial population Gen generated in step 405) is determined by the genetic algorithm. The minimum Q acquired by the evaluation model is 179.9. The genetic algorithm sets the generation number to be 200. In each generation, the genetic algorithm carries out mutation operation through a mixture of adjacent gene mutation, gene insertion mutation, gene exchange mutation, three-point gene exchange mutation, and two-point inversion mutation, and carries out crossover operation through a mixture of partially mapped crossover, cycle crossover operator, edge recombination crossover, linear sequential crossover, ordered crossover operator, and uniform crossover. Finally, the present disclosure determines an optimal surface wireless sensor deployment plan that significantly improves the monitoring capability of the borehole-surface micro-seismic monitoring network deployment plan, as shown in the following table.

| S | x/m | y/m | z/m |
|---|---|---|---|
| S₃₉ | 19382646 | 4322878 | 1400 |
| S₃₈ | 19382646 | 4322678 | 1400 |
| S₃₁ | 19382446 | 4322878 | 1400 |
| S₄₇ | 19382846 | 4322878 | 1400 |
| S₃₀ | 19382446 | 4322678 | 1400 |

What is claimed is:

1. A method for improving a monitoring capability of a borehole-surface micro-seismic monitoring system comprising the following steps:
(1) selecting multiple candidate points for installing surface wireless sensors to form a natural-number-coded candidate point set S={1,2,3,4,5, . . . , n};
(2) combining a fixed number m of candidate points randomly selected from the candidate point set S formed in step (1) with an underground installed sensor set U to form a borehole-surface micro-seismic monitoring network deployment plan Gᵥ=[S₂¹ S₄² . . . Sₙ₋₂^{m} U₁ U₂ . . . Uₖ];
wherein, S₂¹ denotes a candidate point that is a first candidate point randomly selected from the candidate point set S and is a second candidate point in the candidate point set S; similarly, Sₙ₋₂^{m} denotes a candidate point that is an m-th candidate point randomly selected from the candidate point set S and is an (n−2)-th candidate point in the candidate point set S; and k denotes a number of underground sensors;
(3) repeating step (2) until v=p borehole-surface micro-seismic monitoring network deployment plans are generated to form ap-scale deployment plan set G:
$$G = [ \begin{matrix}{G}_{1} \\ {G}_{2} \\ ⋮ \\ {G}_{p}\end{matrix} ]$$
(4) forming, by each borehole-surface micro-seismic monitoring network deployment plan Gᵥ generated in step (3), an initial population Gen:
401) determining, according to a micro-seismic signal acquired by the underground sensor, a propagation relation equation between a micro-seismic energy E and a first-arrival peak amplitude f of a P-wave:
$$f = E {α}_{1} \frac{1}{r} {e}^{- {α}_{2} r}$$
wherein, α₁ denotes an amplitude-energy ratio coefficient; α₂ denotes an attenuation coefficient; and r denotes a distance from a micro-seismic source to the underground sensor;
402) forming a three-dimensional (3D) equidistant grid model comprising
$$floor ( \frac{X max - X min}{d x} + 1 ) \times floor ( \frac{Y max - Y min}{d y} + 1 ) \times floor ( \frac{Z max - Z min}{d z} + 1 )$$
grids with an X-direction spacing dx, a Y-direction spacing dy, and a Z-direction spacing dz for a mining and production area defined by [Xmin, Xmax], [Ymin, Ymax], and [Zmin, Zmax], wherein m₁, n₁, and p₁ denote a number of X-direction grids, a number of Y-direction grids, and a number of Z-direction grids, respectively;
403) rewriting the propagation relation equation determined in step 401) to obtain
$$E = \frac{f r}{{α}_{1} {e}^{- {α}_{{2}^{r}}}} ;$$
and calculating a minimum micro-seismic energy E_{i,j,k}^{min} to trigger the borehole-surface micro-seismic monitoring network deployment plan Gᵥ to record the micro-seismic signal, at a point (Xᵢ, Yⱼ, Zₖ) in the 3D equidistant grid model formed in step 402);
wherein, i∈1,2, . . . , m1; j∈1,2, . . . , n1; k∈1,2, . . . , p1; v∈1,2, . . . , p;
404) establishing, according to step 403), an evaluation model for a monitoring capability Qᵥ of the borehole-surface micro-seismic monitoring network deployment plan Gᵥ:
$${Q}_{v} = \frac{{\sum }_{i = 1}^{{m}_{1}} {\sum }_{j = 1}^{{n}_{1}} {\sum }_{k}^{{p}_{1}} {E}_{i , j , k}^{min}}{{m}_{1} {n}_{1} {p}_{1}}$$
405) forming the initial population Gen:
$$Gen = [ \begin{matrix}{G}_{1} & {Q}_{1} \\ {G}_{2} & {Q}_{2} \\ ⋮ & ⋮ \\ {G}_{p} & {Q}_{p}\end{matrix} ]$$
(5) determining, according to the initial population formed in step (4), an optimal borehole-surface micro-seismic monitoring network deployment plan through a genetic algorithm, and determining an optimal surface wireless sensor deployment plan.

2. The method for improving the monitoring capability of the borehole-surface micro-seismic monitoring system according to claim 1, wherein in step (1), the multiple candidate points selected for installing the surface wireless sensors satisfy the following conditions: the candidate points cooperate with the underground sensors to surround the mining and production area; the candidate points have a distance of no more than 2,000 m from the mining and production area; the candidate points avoid a waterlogged area, a surface water system, a highway facility, and a noisy place; and the candidate points provide strong fourth-generation/fifth-generation (4G/5G) network signals.

3. The method for improving the monitoring capability of the borehole-surface micro-seismic monitoring system according to claim 1, wherein step 401) comprises: determining α₁ and α₂ as follows: manually marking the first-arrival peak amplitude f of the P-wave recorded by each underground sensor; calculating a source position and micro-seismic energy E of multiple micro-seismic signals with different energy levels; calculating a distance r from the micro-seismic source to the underground sensor; and determining α₁ and α₂ by a nonlinear least squares (NLS) method.

4. The method for improving the monitoring capability of the borehole-surface micro-seismic monitoring system according to claim 2, wherein step 401) comprises: determining α₁ and α₂ as follows: manually marking the first-arrival peak amplitude f of the P-wave recorded by each underground sensor; calculating a source position and micro-seismic energy E of multiple micro-seismic signals with different energy levels; calculating a distance r from the micro-seismic source to the underground sensor; and determining α₁ and α₂ by a nonlinear least squares (NLS) method.

5. The method for improving the monitoring capability of the borehole-surface micro-seismic monitoring system according to claim 3, wherein in step 403), the calculating a minimum micro-seismic energy E_{i,j,k}^{min} to trigger the borehole-surface micro-seismic monitoring network deployment plan Gᵥ to record the micro-seismic signal, at a point (Xᵢ, Yⱼ, Zₖ) comprises:
40301: determining, according to a micro-seismic positioning principle based on a first arrival time of the P-wave, that the micro-seismic monitoring system is triggered to record the micro-seismic signal when the first-arrival peak amplitude f of the P-wave received by at least four sensors is greater than or equal to three times an ambient noise level NL;
40302: calculating a distance rₗ from the point (Xᵢ,Yⱼ, Zₖ) to each sensor in the borehole-surface micro-seismic monitoring network deployment plan Gᵥ; determining, according to step 40301, a first-arrival peak amplitude fₗ, of the P-wave required to trigger each sensor; and back-calculating, according to the propagation relation equation between the micro-seismic energy E and the first-arrival peak amplitude f of the P-wave determined in step 401, a micro-seismic energy E_{i,j,k}^{l} required to trigger each sensor:
$${E}_{i , j , k}^{l} = \frac{{f}_{l} {r}_{l}}{{α}_{1} {e}^{- {α}_{{2}^{r} l}}} ,$$
$$wherein , l = 1 , 2 , … , m + k$$
40303: sorting, according to step 40301, the micro-seismic energy E_{i,j,k}^{l} calculated in step 40302 in an ascending order; and selecting a fourth micro-seismic energy after the sorting as the minimum micro-seismic energy E_{i,j,k}^{min} to trigger the borehole-surface micro-seismic monitoring network deployment plan to record the micro-seismic signal.

6. The method for improving the monitoring capability of the borehole-surface micro-seismic monitoring system according to claim 5, wherein in step 40301, the ambient noise level NL comprises a surface ambient noise level NLₛ monitored by the surface sensor installed on a surface and an underground ambient noise level NLᵤ monitored by the underground sensor installed in an underground roadway.

7. The method for improving the monitoring capability of the borehole-surface micro-seismic monitoring system according to claim 6, wherein in step (5), the genetic algorithm sets a generation number of not less than 100; and the genetic algorithm carries out mutation operation through a mixture of adjacent gene mutation, gene insertion mutation, gene exchange mutation, three-point gene exchange mutation, and two-point inversion mutation, and carries out crossover operation through a mixture of partially mapped crossover, cycle crossover operator, edge recombination crossover, linear sequential crossover, ordered crossover operator, and uniform crossover.
